(19) United States
(12) Patent Application Publication
(10) Pub. No.: US 2024/0411525 A1
(43) Pub. Date: Dec. 12, 2024

(54) TRACKING AND COMPARING CHANGES IN A DESIGN INTERFACE

(71) Applicant: Figma, Inc., San Francisco, CA (US)

(72) Inventors: Kiko Lam, San Francisco, CA (US); Jessica Leary, San Francisco, CA (US); Avantika Gomes, San Francisco, CA (US); Bradley Artziniega, San Francisco, CA (US); Karl Jiang, San Francisco, CA (US); Nathan Tsai, San Francisco, CA (US); Mattie Sanseverino, San Francisco, CA (US); Linda Qin, San Francisco, CA (US)

(21) Appl. No.: 18/737,843

(22) Filed: Jun. 7, 2024

Related U.S. Application Data
(60) Provisional application No. 63/472,199, filed on Jun. 9, 2023.

(51) Int. Cl. G06F 8/20

(52) U.S. Cl. CPC G06F 8/20

(57) ABSTRACT

A network computer provides interactive graphic design system instructions for execution at a user computing device. The user computing device determines a first set of differences between a first version of a design interface and a second version of the design interface based on a comparison of a first set of workspace data for the first version of the design interface with a second set of workspace data for the second version of the design interface and renders on a canvas, the first version of the design interface for display to a user at the user computing device. The user interface also renders, within the canvas, one or more visual representations of the first set of differences between the first version of the design interface and the second version of the design interface.

### RELATED APPLICATIONS

This application claims priority to Provisional U.S. Patent Application No. 63/472,199, filed Jun. 9, 2023; the aforementioned priority application being hereby incorporated by reference in its entirety.

### TECHNICAL FIELD

Examples described herein relate to a network computer system, and relate more specifically to tracking and comparing design changes in interactive graphic design systems.

### BACKGROUND

Software design tools have many forms and applications. In the realm of application user interfaces, for example, software design tools require designers to blend functional aspects of a program with aesthetics and even legal requirements, resulting in a collection of pages that form the user interface of an application. For a given application, designers often have many objectives and requirements that are difficult to track.

### BRIEF DESCRIPTION OF THE DRAWINGS

FIG. 1A illustrates an interactive graphic design system for a computing device of a user, according to one or more examples.

FIG. 1B illustrates a network computing system to implement an interactive graphic design system on a user computing device, according to one or more examples.

FIG. 1C illustrates a network computing system to implement an interactive graphic design system for multiple users in a collaborative network platform, according to one or more examples.

FIGS. 2A-2D illustrate example user interfaces that include visual representations of differences between two versions of a design interface, according to one or more examples.

FIG. 3 illustrates a process for tracking and comparing changes in a design interface, according to one or more examples.

FIG. 4A illustrates a process for generating an entry point to a compare changes interface, according to one or more examples.

FIG. 4B illustrates a process for generating an entry point to a compare changes interface, according to one or more examples.

FIG. 5 illustrates a computer system on which one or more embodiments can be implemented.

FIG. 6 illustrates a user computing device for use with one or more examples, as described.

### DETAILED DESCRIPTION

Examples include a computer system that can operate to implement an interactive graphic design system that enables users to track and compare changes to a design interface. In examples, a computer system is configured to implement an interactive graphic design system for designers, such as user interface designers (“UI designers”), web designers, and web developers. Among other advantages, examples as described enable such users to compare changes between different versions of a design interface as the design interface is updated over time by the same users and/or different users. Different versions of the design interface may be accessed and/or modified independently of each other, and may have separate data, files, addresses, and/or other properties. The examples further enable such users to review the design changes by visually highlighting and/or otherwise indicating the design changes “in context” within a canvas that serves as a backdrop for the design interface.

Examples may be deployed in a collaborative environment, and may streamline the management of large design systems and improve the efficient functioning of computers in generating, updating, and navigating across versions of design interfaces. For example, a conventional design tool may provide a version history that includes a timeline and/or list of different versions of a design. In an attempt to determine changes that were made between an older version of the design and a newer version of the design, a user may repeatedly toggle between viewing the older version and viewing the newer version within the conventional design tool. As this toggling is performed, the conventional design tool may consume resources during retrieval of a given version of the design from storage, displaying the version of the design, and/or processing interactions (e.g., zooming, scrolling, searching, editing, etc.) between the user and the displayed design. However, the user may be unable to detect subtle changes (e.g., small changes in style, dimensions, etc.) between the versions via this toggling, as the changes are not highlighted or otherwise visually indicated. In contrast, the disclosed embodiments efficiently determine differences between two or more versions of a design interface via comparisons of hierarchical structures associated with the versions and display visual representations of the differences within a canvas populated with the design interface. The visual representations can be used to quickly detect, review, comment on, accept, reject, and/or otherwise operate on changes made to the design interface between the two versions without incurring additional time and resource overhead associated with toggling between views of the two versions.

According to some examples, a computing device operates to receive interactive graphic design system instructions and workspace data describing one or more design interfaces. The computing device determines a first set of differences between a first version of a design interface and a second version of the design interface based on a comparison of a first set of workspace data for the first version of the design interface with a second set of workspace data for the second version of the design interface. The computing device renders, on a canvas, the first version of the design interface for display to a user at the user computing device. The computing device renders, within the canvas, one or more visual representations of the first set of differences between the first version of the design interface and the second version of the design interface.

Still further, in some examples, a network computer system includes memory resources storing a set of instructions, and one or more processors operable to communicate the set of instructions to a plurality of user devices. The set of instructions can be communicated to user computing devices and executed at the user computing devices to render a version of a design interface on a canvas. The version of the design interface can be edited by user input that is indicative of any one of multiple different input actions. The set of instructions can be executed on the computing devices to cause each of the computing devices to determine one or more input actions to perform based on user input. The instructions may further cause the user computing devices to modify the version of the design interface, create a new version of the design interface, generate visual representations of differences between the version of the design interface and another version of the design interface, and/or generate other output based on one or more input actions.

In some examples, for at least a first computing device, the instructions can be executed to cause the computing device to determine a first set of differences between a first version of a design interface and a second version of the design interface based on a comparison of a first set of workspace data for the first version of the design interface with a second set of workspace data for the second version of the design interface. The computing device renders, on a canvas, the first version of the design interface for display to a user at the user computing device. The computing device renders, within the canvas, one or more visual representations of the first set of differences between the first version of the design interface and the second version of the design interface.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices and/or tablets), and magnetic memory. Computers, terminals, network-enabled devices (e.g., mobile devices, such as cell phones) are all examples of machines and devices that utilize processors, memory, and instructions stored on computer-readable mediums. Additionally, embodiments may be implemented in the form of computer-programs, or a computer-usable carrier medium capable of carrying such a program.

### System Description

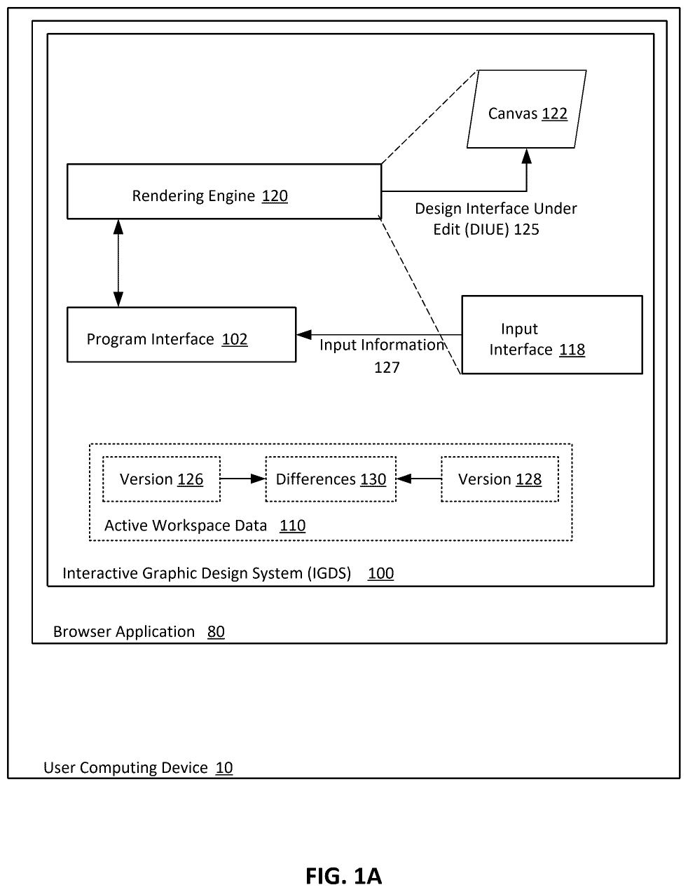

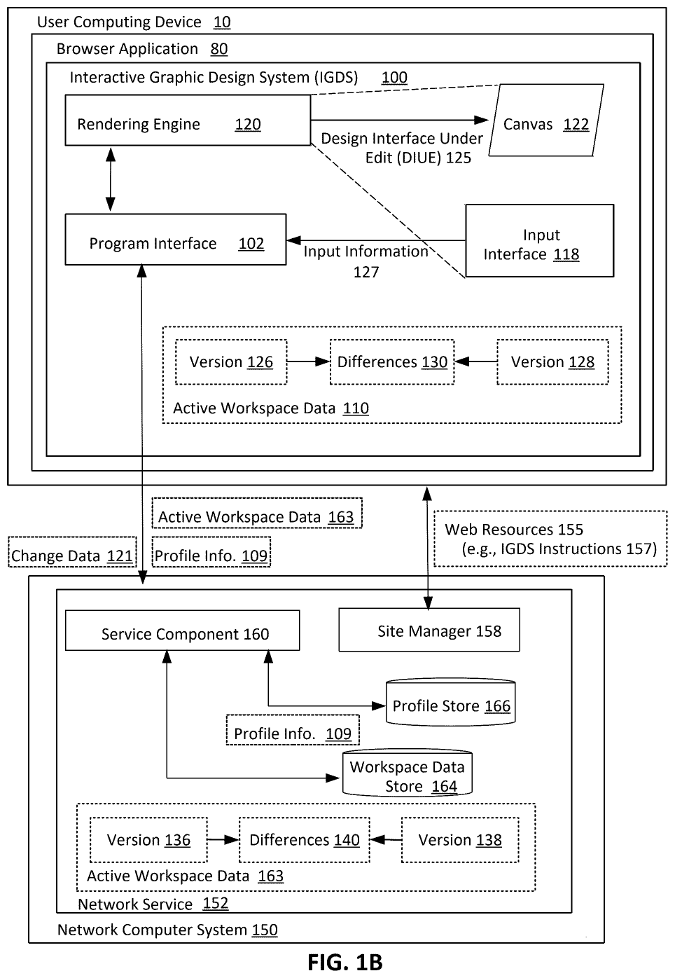

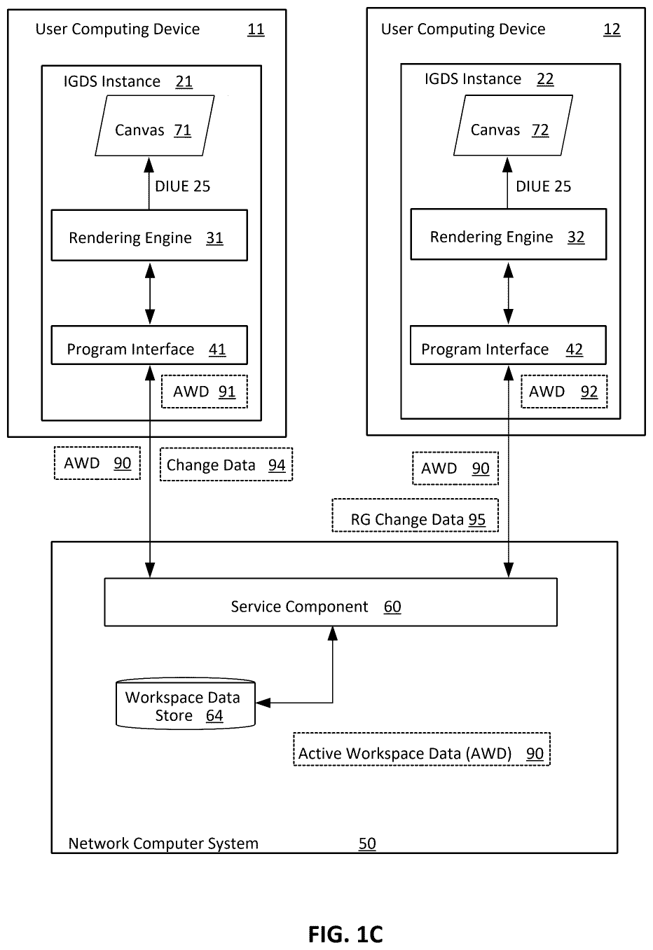

FIG. 1A illustrates an interactive graphic design system (IGDS) 100 for a computing device of a user, according to one or more examples. The IGDS 100 can be implemented in any one of multiple different computing environments. For example, in some variations, the IGDS 100 can be implemented as a user-side application that executes on the user computing device 10 to provide functionality as described with various examples. In another example, as described below, the IGDS 100 can be implemented as a web application that executes in a browser application 80. As an addition or alternative, the IGDS 100 may be implemented as a native application developed for use on a particular platform, such as but not limited to LINUX, ANDROID, WINDOWS, or another platform. As an addition or alternative, the IGDS 100 can be implemented as a distributed system, such that processes described with various examples execute on a network computer (e.g., server) and on the user device 10.

According to examples, the IGDS 100 can be implemented on a user computing device 10 to enable a corresponding user to create, view, and/or modify various types of design interfaces using graphical elements. A design interface may include any layout of content and/or interactive elements, such as (but not limited to) a web page. The IGDS 100 can include processes that execute as or through a browser application 80 that is installed on the computing device 10.

As used herein, the term “browser application” refers to any program that accesses web content over a network, such as by using the Hypertext Transfer Protocol (HTTP) to access information resources over the Internet. In some examples, the browser application 80 is a commercially available browser application, such as but not limited to GOOGLE CHROME (developed by GOOGLE, INC.), SAFARI (developed by APPLE, INC.), and EDGE/INTERNET EXPLORER (developed by the MICROSOFT CORPORATION). As described by various examples, a browser application 80 can execute scripts, code, and/or other logic (the “programmatic components”) to implement the functionality of the IGDS 100. Additionally, in some variations, the IGDS 100 can be implemented as part of a network service, where the browser application 80 communicates with one or more remote computers (e.g., server used for a network service) to execute processes of the IGDS 100.

The browser application 80 can retrieve some or all of the programmatic resources for implementing the IGDS 100 from a network site. As an addition or alternative, the browser application 80 can retrieve some or all of the programmatic resources from a local source (e.g., local memory residing with the computing device 10). The browser application 80 may also access various types of data sets in providing the IGDS 100. The data sets can correspond to files and/or libraries, which can be stored remotely (e.g., on a server, in association with an account, etc.) or locally.

The IGDS 100 can be implemented as web code that executes in a browser application 80. This web code can include (but is not limited to) HyperText Markup Language (HTML), JAVASCRIPT, Cascading Style Sheets (CSS), other scripts, and/or other embedded code which the browser application 80 downloads from a network site. For example, the browser application 80 can execute web code that is embedded within a web page, causing the IGDS 100 to execute at the user computer device 10 in the browser application 80. The web code can also cause the browser application 80 to execute and/or retrieve other scripts and programmatic resources (e.g., libraries) from the network site and/or other local or remote locations. By way of example, the browser application 80 may include JAVASCRIPT embedded in an HTML resource (e.g., web page structured in accordance with HTML 5.0 or other versions, as provided under standards published by W3C or WHATWG consortiums) that is executed by the browser application 80. In some examples, the rendering engine 120 and/or other components may utilize graphics processing unit (GPU) accelerated logic, such as provided through WebGL (Web Graphics Library) programs which execute Graphics Library Shader Language (GLSL) programs that execute on GPUs.

A user of the computing device 10 can operate the browser application 80 to access a network site, where programmatic resources are retrieved and executed to implement the IGDS 100. In this way, the user may initiate a session to implement the IGDS 100 to create, view, and/or modify a design interface. In some embodiments, the IGDS 100 includes a program interface 102, an input interface 118, and a rendering engine 120. The program interface 102 can include one or more processes that execute to access and retrieve programmatic resources from local and/or remote sources.

In some implementations, the program interface 102 can generate a canvas 122 using programmatic resources that are associated with the browser application 80 (e.g., an HTML 5.0 canvas). As an addition or variation, the program interface 102 can trigger or otherwise cause the canvas 122 to be generated using programmatic resources and data sets (e.g., canvas parameters) which are retrieved from local (e.g., memory) or remote sources (e.g., from network service).

The program interface 102 may also retrieve programmatic resources that include an application framework for use with the canvas 122. The application framework can include data sets that define or configure a set of interactive graphic tools that integrate with the canvas 122. For example, the interactive graphic tools may include an input interface 118 to enable the user to provide input for creating and/or editing a design interface.

According to some examples, the input interface 118 can be implemented as a functional layer that is integrated with the canvas 122 to detect and interpret user input, such as the input interface 118. In one or more embodiments, the input interface 118 includes a user interface that can, for example, use a reference of the canvas 122 to identify a screen location of a user input (e.g., ‘click’). Additionally, the input interface 118 can interpret an input action of the user based on the location of the detected input (e.g., whether the position of the input indicates selection of a tool, an object rendered on the canvas, or region of the canvas), the frequency of the detected input in a given time period (e.g., double-click), and/or the start and end position of an input or series of inputs (e.g., start and end position of a click and drag), as well as various other input types which the user can specify (e.g., right-click, screen-tap, etc.) through one or more input devices. In this manner, the input interface 118 can interpret, for example, a series of inputs as a design tool selection (e.g., shape selection based on location/s of input), as well as inputs to define properties (e.g., dimensions) of a selected shape.

Additionally, the program interface 102 can be used to retrieve, from local or remote sources, programmatic resources and data sets that include active workspace data 110. As used herein, the term “workspace data” refers to data describing a design interface that can be loaded by the IGDS 100, the term “design interface under edit” refers to a design interface that is loaded in the IGDS 100, and the term “active workspace data” refers to workspace data describing a design interface under edit (DIUE) that is loaded in the IGDS 100.

The retrieved data sets can include one or more pages that include design elements that collectively form a design interface, or a design interface that is in progress. For example, the program interface 102 may be used to retrieve one or more files storing active workspace data 110. This active workspace data 110 can additionally include one or multiple data structure representations that collectively define the DIUE 125. For example, the active workspace data may include multiple versions (e.g., versions 126 and 128) of a design interface. When a version of the design interface is selected as the DIUE 125, the program interface 102 may retrieve and load the corresponding version of workspace data as active workspace data 110.

The IGDS 100 may also load and/or request additional data sets that are associated with the active workspace. As an example, the program interface 102 can retrieve, from local memory or another source (e.g., network service 152 of FIG. 1B), one or more types of profile information (e.g., profile information 109 of FIG. 1B), such as user profile information that identifies past activities of the user of the computing device 10 when utilizing the IGDS 100. The profile information can identify, for example, input types (or actions) of the user with respect to the page(s) of the active workspace, or more generally, input actions of the user in a prior time interval. In some variations, the profile information can also identify historical or contextual information about individual design interfaces associated with the profile.

The rendering engine 120 renders the DIUE 125 described by the active workspace data 110 on the canvas 122. For example, when a given version of a design interface is selected as the DIUE 125, the rendering engine 120 renders the design interface as described by the corresponding version of workspace data loaded as the active workspace data 110. The DIUE 125 includes graphic elements and their respective properties as described by the active workspace data 110. The user can edit the DIUE 125 using the input interface 118. As an addition or alternative, the rendering engine 120 can generate a blank page for the canvas 122, and the user can use the input interface 118 to generate the DIUE 125. As rendered, the DIUE 125 can include graphic elements such as a background and/or a set of objects (e.g., shapes, text, images, programmatic elements), as well as properties of the individual graphic elements. Each property of a graphic element can include a property type and a property value. For an object, the types of properties include shape, dimension (or size), layer, type, color, line thickness, font color, font family, font size, font style, and/or other visual characteristics. Depending on implementation details, the properties reflect attributes of two- or three-dimensional designs. In this way, property values of individual objects can define visual characteristics such as size, color, positioning, layering, and content for elements that are rendered as part of the DIUE 125. Workspace data, such as the active workspace data 110 corresponding to the DIUE 125, can describe one or more objects belonging to the design interface.

Individual design elements may also be defined in accordance with a desired run-time behavior. For example, some objects can be defined to have run-time behaviors that are either static or dynamic. The properties of dynamic objects may change in response to predefined run-time events generated by the underlying application that is to incorporate the DIUE 125. Additionally, some objects may be associated with logic that defines the object as being a trigger for rendering or changing other objects, such as through implementation of a sequence or workflow. Still further, other objects may be associated with logic that provides the design elements to be conditional as to when they are rendered and/or their respective configuration or appearance when rendered. Still further, objects may also be defined to be interactive, where one or more properties of the object may change based on user input during the run-time of the application.

The input interface 118 can process at least some user inputs to determine input information 127, where the input information 127 indicates (i) an input action type (e.g., shape selection, object selection, sizing input, color selection), (ii) an object or objects that are affected by the input action (e.g., an object being resized), (iii) a desired property that is to be altered by the input action, and/or (iv) a desired value for the property being altered. The program interface 102 can receive the input information 127, and the program interface 102 can implement changes indicated by the input information 127 to update the active workspace data 110. The rendering engine 120 can update the canvas 122 to reflect the changes to the affected objects in the DIUE 125. For example, when a given version of the design interface is selected as the DIUE 125, the program interface 102 updates the corresponding version of active workspace data 110, and the rendering engine 120 updates the canvas 122 to reflect changes to the design interface indicated by the input information 127.

### Tracking Changes to a Design Interface

As a design interface is updated over time, different versions of the design interface may be used to delineate, track, and/or revert changes to the design interface. For example, IGDS 100 may automatically generate a new version of the design interface (e.g., a “checkpoint”) after a certain period of inactivity in editing the design interface. In another example, a user may manually create a new version of the design interface after a certain set of changes has been made to the design interface. In a third example, a user may view and/or restore an older version of the design interface to edit layers, export assets, and/or perform other actions. Actions pertaining to a given version of the design interface may be safely performed (e.g., to implement a proposed design change) without affecting other versions of the design interface.

In some embodiments, a version history for a design interface lists different versions of the design interface ordered by time of creation, creator, name, and/or another attribute. The version history may be displayed in a sidebar next to the canvas 122 by IGDS 100 and/or in another portion of a user interface provided by IGDS 100. A user may use the input interface 118 in conjunction with the displayed version history to view a version of the design interface, restore a previous version of the design interface, duplicate a version, share a link to a version with other users, create new versions of the design interface, add or modify the name and/or description of a version, delete a version and/or metadata associated with the version, and/or perform other actions related to the version history. For example, the input interface 118 may provide a menu, buttons, toggles, and/or other user-interface elements that allow the user to perform actions related to the version history of a design interface.

When a new version of the design interface is created, the IGDS 100 obtains a corresponding version of workspace data for the new version as active workspace data 110. The IGDS 100 may generate the active workspace data 110 based on a previously retrieved version of active workspace data 110 and changes made to the previous version of active workspace data 110 on user computing device 10. As an alternative or addition, the IGDS 100 may obtain the active workspace data 110 from a network computer system (e.g., network computer system 150, 50) that generates the active workspace data 110 from a corresponding set of workspace data 163 at the network computer system. For example, the IGDS 100 may request the active workspace data 163 from the service component 160 of the network computer system 150 and maintain a user-side copy of the active workspace data 163.

In some examples, the IGDS 100 is configured to determine a set of differences 130 between two versions 126 and 128 of a design interface. As described in further detail below, these differences 130 can be determined by comparing hierarchical structures that are defined by the corresponding sets of workspace data for the versions 126 and 128. The differences 130 may also be associated with “chunks” that represent logical groupings under nodes of the hierarchical structures. Visual representations of these chunked differences 130 may additionally be rendered within canvas 122 to allow users to easily locate, track, and/or compare changes made between the versions 126 and 128 of the design interface.

### Network Computing System to Implement IGDS

FIG. 1B illustrates a network computer system to implement the IGDS 100 on a user computing device, according to one or more examples. A network computer system 150 can be implemented using one or more servers that communicate with user computing devices over one or more networks. In some examples, the network computer system 150 performs operations to enable the IGDS 100 to be implemented on the user computing device 10.

In variations, the network computer system 150 provides a network service 152 to support the use of the IGDS 100 by one or more user computing devices, including a user computing device 10 that utilizes a browser application 80. The network computer system 150 can include a site manager 158 that manages a website where a set of web resources 155 (e.g., web pages, web code, and/or other web resources) are made available for site visitors. The web resources 155 can include instructions, such as scripts or other logic, which are executable by browsers or web components of user computing devices. In some variations, once the browser application 80 accesses and downloads the web resources 155, the browser application 80 executes the IGDS instructions 157 to implement functionality such as described with some examples of FIG. 1A. For example, the IGDS instructions 157 can be executed by browser application 80 to initiate the program interface 102 on the user computing device 10. The initiation of the program interface 102 may coincide with the establishment of, for example, a web-socket connection between the program interface 102 and a service component 160 of the network computer system 150.

In some examples, the IGDS instructions 157, when executed in the browser application 80, initiate one or more processes of the program interface 102, causing the IGDS 100 to retrieve additional programmatic resources and data sets for implementing functionality as described herein by one or more examples. The web resources 155 can, for example, embed logic (e.g., JAVASCRIPT code), including GPU accelerated logic, in an HTML page for download by computing devices of users. The program interface 102 can be triggered to retrieve additional programmatic resources and data sets from, for example, the network service 152, and/or from local resources of the computing device 10. For example, some of the components of the IGDS 100 can be implemented through web pages that can be downloaded onto the user computing device 10 after authentication is performed, and/or once the user performs additional actions (e.g., downloading one or more pages of the workspace associated with the account identifier). Accordingly, in one or more examples as described, the network computer system 150 can communicate the IGDS instructions 157 to the user computing device 10 through a combination of network communications, where the IGDS instructions 157 are received and executed by the browser application 80.

Upon accessing the website, the browser application 80 can automatically (e.g., through saved credentials) or through manual input, communicate an account identifier to the service component 160. In some examples, the browser application 80 can also communicate one or more additional identifiers that correlate to a user identifier. Additionally, in some examples, the service component 160 can use the user or account identifier of the user identifier to retrieve profile information 109 from a user profile store 166. As an addition or variation, profile information 109 for the user can be determined and stored locally on the user computing device 10. The service component 160 may also determine, based on the user credentials, a permission setting or role of the user in connection with the account identifier. The permission settings or role of the user can determine, for example, workspace data that can be accessed by the user. In some examples, the implementation of the rendering engine 120 on the user computing device 10 can be configured based at least in part on the role or setting of the user and/or affiliation of the user with a particular organization.

The service component 160 can also retrieve and provide workspace data describing a workspace that is linked to the user account or identifier from a workspace data store 164. For example, when a user selects a particular design interface to load in the IGDS 100, the program interface 102 may submit a request to the service component 160. The service component 160 may access the workspace data store 164 to retrieve the corresponding active workspace data 163 and provide the active workspace data 163 to the IGDS 100.

The active workspace data 163 may be associated with one or more versions 136 and 138 of the design interface. When a user selects a version of the design interface, the program interface 102 may submit a request to the service component 160, which retrieves the corresponding set of workspace data from the workspace data store 164 and provides the set of workspace data as active workspace data 163 to the IGDS 100. The IGDS 100 may maintain a user-side copy of the received version of the active workspace data 163 (e.g., as active workspace data 110).

When a new version of the design interface is created, the user computing device 10 may create a corresponding set of user-side active workspace data 110 and provide the set of user-side active workspace data 110 to the network computer system 150 so that the network computer system 150 can work with, store, update, and serve the active workspace data 110. As an alternative or addition, the program interface 102 may send a request to the service component 160 so that the service component 160 generates a corresponding set of active workspace data 163 at the network computer system 150. The service component 160 may provide the generated active workspace data 163 to the program interface 102 in response to the request. The IGDS 100 may maintain a user-side copy of the received active workspace data 163 (e.g., as active workspace data 110). The network computer system 150 may store the active workspace data 163 in the workspace data store 164 and make the active workspace data 163 available to other users.

In some examples, the input interface 118 includes a file browser that allows users with the proper permissions to access design interfaces and/or specific versions of design interfaces. The access control for specified users to view, edit, or perform other operations on a given version of a design interface may be the same as or different than access control for other versions of the design interface.

In some examples, the IGDS 100 maintains user-side active workspace data 110 corresponding to the active workspace data 163 received from the network computer system 150. For example, the user-side active workspace data 110 may begin as a copy of the received active workspace data 163 that is stored in memory at the user computing device 10. In some examples, the IGDS 100 initiates the canvas 122 and renders the corresponding design interface under edit (DIUE) 125 to the canvas 122 based on the active workspace data 110. For example, the IGDS 100 can initiate an HTML 5.0 canvas as a component of the browser application 80, and the rendering engine 120 can render the corresponding DIUE 125 on the canvas 122.

In some examples, any changes to the DIUE 125 made using the IGDS 100 can also be updated in the user-side active workspace data 110, as stored on the computing device 10. In some embodiments, the program interface 102 sends change data 121 to the network computer system 150. The change data 121 reflects one or more changes to the DIUE 125 made in the IGDS 100 and to the user-side active workspace data 110. For example, the program interface 102 can stream change data 121 to the service component 160 periodically and/or in real-time as changes are made at the user computing device 10.

At the network computer system 150, the service component 160 can receive the change data 121, which in turn can be used to implement changes to the server-side active workspace data 163. In this way, the server-side active workspace data 163 at the network computer system 150 can mirror (or be synchronized with) the user-side active workspace data 110 on the user computing device 10. For example, the program interface 102 can stream the changes as change data 121 to the service component 160 to synchronize the user-side active workspace data 110 and the server-side active workspace data 163 corresponding to the DIUE 125. This process can be performed repeatedly or continuously so that the user-side active workspace data 110 and the server-side active workspace data 163 describing the DIUE 125 remain synchronized.

### Collaborative Network Platform

FIG. 1C illustrates a network computer system to implement an interactive graphic design system for multiple users in a collaborative network platform, according to one or more examples. In an example of FIG. 1C, a collaborative network platform is implemented by the network computer system 50, which communicates with multiple user computing devices 11-12 over one or more networks (e.g., the World Wide Web) to implement interactive graphic design system (IGDS) instances 21-22 on the user computing devices 11-12. While FIG. 1C illustrates an example in which two users utilize the collaborative network platform, examples as described allow for the network computer system 50 to enable collaboration on design interfaces among users using a larger number of user computing devices. Among other advantages, the collaborative network platform allows users to more concurrently access a design interface, and to conveniently manipulate objects based on a shared property value while the network computer system 50 manages synchronization and access issues.

With respect to FIG. 1C, the user computing devices 11-12 can be assumed as being operated by users that are associated with a common account or accounts associated with the same design interface. Each user computing device 11-12 implements an IGDS instance 21-22 to access the same design interface (e.g., DIUE 25) during respective sessions that overlap with one another. Accordingly, each of the user computing devices 11-12 may access the same set of active workspace data 90 at the same time, with the respective program interface 41-42 of the IGDS instance 21-22 operating to establish a corresponding communication channel (e.g., a web socket connection) with the service component 60. In examples, the service component 60 can load the active workspace data 90 corresponding to the DIUE 25 from a workspace data store 64, and transmit a copy of the active workspace data 90 to each user computing device 11-12 such that the respective rendering engines 31-32 render the DIUE 25 corresponding to the active workspace data 90 at the same time, such as during overlapping sessions.

In some examples, after receiving the active workspace data 90, the IDGS instance 21 maintains user-side active workspace data 91 at user computing device 11, and the IDGS instance 22 maintains user-side active workspace data 92 at user computing device 12. The service component 60 can also maintain network-side active workspace data 90 for the DIUE 25 loaded by the IGDS instances 21-22.

In some examples, the network computer system 50 can continuously synchronize the active workspace data 90-92 corresponding to the DIUE 25 loaded in one or more IGDS instances 21-22 on the user computing devices 11-12. Thus, changes made by users to the DIUE 25 on one user computing device 11 may be reflected on the DIUE 25 rendered on the other user computing device 12 in real-time. By way of example, when a change is made to the DIUE 25 at one user computing device 11, the respective rendering engine 31 updates the respective canvas 71, and the respective program interface 41 updates the respective user-side active workspace data 91. The respective program interface 41 of the IGDS instance 21 transmits change data 94 reflecting the DIUE 25 change to the service component 60. The service component 60 processes the change data 94 from the user computing device 11 and uses the change data 94 to make a corresponding change to the server-side active workspace data 90. The service component 60 can also transmit remotely-generated change data 95 (which in the example provided, corresponds or reflects the change data 94 received from the user computing device 11) to the other user computing device 12 that has loaded the same DIUE 25, causing the corresponding IGDS instance 22 to update the DIUE 25, such as by causing the program interface 42 to update the corresponding user-side active workspace data 92 and causing the respective rendering engine 32 to update the respective canvas 72. In this manner, active workspace data 91-92 is synchronized across any user computing devices 11-12 that are using the respective workspace data.

To facilitate the synchronization of the active workspace data 90-92 at the user computing devices 11-12 and the network computer system 50, the network computer system 50 may implement a stream connector to merge data streams between the network computer system 50 and user computing devices 11-12 that have loaded the same DIUE 25. For example, the stream connector may merge a first data stream between user computing device 11 and the network computer system 50 with a second data stream between user computing device 12 and the network computer system 50. In some implementations, the stream connector can be implemented to enable each computing device 11-12 to make changes to the server-side active workspace data 90 without added data replication that may otherwise be required to process the streams from each user computing device 11-12 separately.

Additionally, over time, one or more sets of user-side active workspace data 91-92 may become out-of-sync with the server-side active workspace data 90. In such cases, the respective computing device 11-12 can re-download some or all of the server-side active workspace data 90 to restart its maintenance of the corresponding user-side active workspace data 91-92 and DIUE 25 rendered on the respective canvas 71-72.

### Comparing Changes Across Versions of a Design Interface

After a new version of a design interface is created, the active workspace data 110 or 163 for the new version may be accessed and/or modified without affecting workspace data for other (e.g., older) versions of the design interface. For example, the active workspace data 110 or 163 for the new version of the design interface may include a new set of data, files, addresses, version histories, access permissions, and/or other separate properties. Change input actions made in the IGDS 100 to the new version of the design interface by one or more users are reflected in the active workspace data 110 or 163.

In some embodiments, the IGDS 100 includes functionality to determine a set of differences 130 or 140 between different versions of the design interface. For example, the IGDS 100 may identify the set of differences 130 between versions 126 and 128 of the design interface that are associated with active workspace data 110 at the user computing device 10. As an alternative or addition, the IGDS 100 may obtain the set of differences over a network, such as by sending a request over the Internet to a network computer system (e.g. network computer system 150, 50) that supports the IGDS 100 at one or more user computing devices. In this case, the network computer system generates the set of differences 140 between versions 136 and 138 of the design interface that are associated with active workspace data 163 maintained by the network computer system.

The differences may be identified between any two versions of the design interface. For example, the set of differences may be determined between a current (e.g., latest) version of the design interface and an older version of the design interface. As an alternative or addition, the set of differences may be determined between two versions of the design interface that are both older than the current version of the design interface.

In some examples, a design interface is represented as a graph that includes a set of nodes arranged in graph or other hierarchical structure. Workspace data for a design interface may include data describing the set of nodes along with data describing the hierarchical structure. The set of differences between two versions of the design interface may include (but is not limited to) changes within a particular node, the addition of a particular node (e.g., in a newer version of the design interface), the removal of a particular node (e.g., from an older version of the design interface), and/or the movement of a particular node in the hierarchical structure. A particular node that includes a difference may affect child nodes and/or parent nodes. The differences are described in greater detail hereinafter.

The identified set of differences may be used to perform operations such as visually rendering or capturing the differences between two versions of the design interface for review, tracking differences across members of a collaborative team, and/or selecting a version of the design interface for further development and/or implementation.

In examples, the set of differences can be displayed to a developer to enable the developer to readily detect changes made to the design interface. Through inspection of differences, the developer can readily detect changes, to facilitate the developer in updating a code set for implementing the design interface in a production environment. In some examples, the design interface can be integrated with an interface that automatically generates or displays code for implementing a particular portion of the design interface. When differences are displayed to the user, the developer can use the design interface to automatically navigate to a portion of the code which is affected by the changes to the design interface.

### Examples—Visualization of Differences

The IGDS 100 is also configured to render a “compare changes” interface for display to the user. The compare changes interface includes visual representations of at least one difference between two versions of a design interface. A visual representation may include a rendering of a design element and/or another portion of the design interface, a thumbnail rendering, an abstract representation (e.g., a color swatch, typeface), and/or another visual representation. One or more visual representations may be displayed “in context” within the canvas 122 for a given version of the design interface.

The IGDS 100 may present the compare changes interface based on and/or using various types of interaction between a user and the input interface 118. For example, the IGDS 100 may determine, based on the time at which the user last accessed the design interface and/or interacted with the IGDS 100, that one or more new versions of the design interface have been created since the version previously displayed to the user. When the user subsequently interacts with the IGDS 100, the IGDS 100 may generate an alert or notification indicating that changes have been made to the design interface since the user's previous visit. The user may click on the alert or notification to navigate to the compare changes interface. In another example, the program interface 102 may display a version history that includes a list of versions of the design interface ordered by time (or another attribute). The user may provide input through input interface 118 that “hovers” over a given version in the design history to access the compare changes interface. The user may also, or instead, use the version history and/or compare changes interface to select one or both versions 126 and/or 128 of the design interface from which differences 130 are determined and visually represented.

Within the compare changes interface, the differences 130 between two versions 126 and 128 of the design interface are indicated using various types of visual representations that are displayed within the canvas 122 on which one of the versions is rendered. These visual representations include “on-canvas” labels that identify specific parts of the rendered version of the design interface as affected by one or more differences 130. Each on-canvas label may represent a chunk of one or more differences 130 between the two versions 126 and 128 of the design interface. Each on-canvas label may also, or instead, indicate a type of change associated with the one or more differences, such as (but not limited to) an addition of a design element, editing of a design element, removal of a design element, and/or a change to an external library. These visual representations can also, or instead, include listing and/or highlighting of frames, layers, pages, and/or other parts of one version of the design interface that are affected by the differences 130.

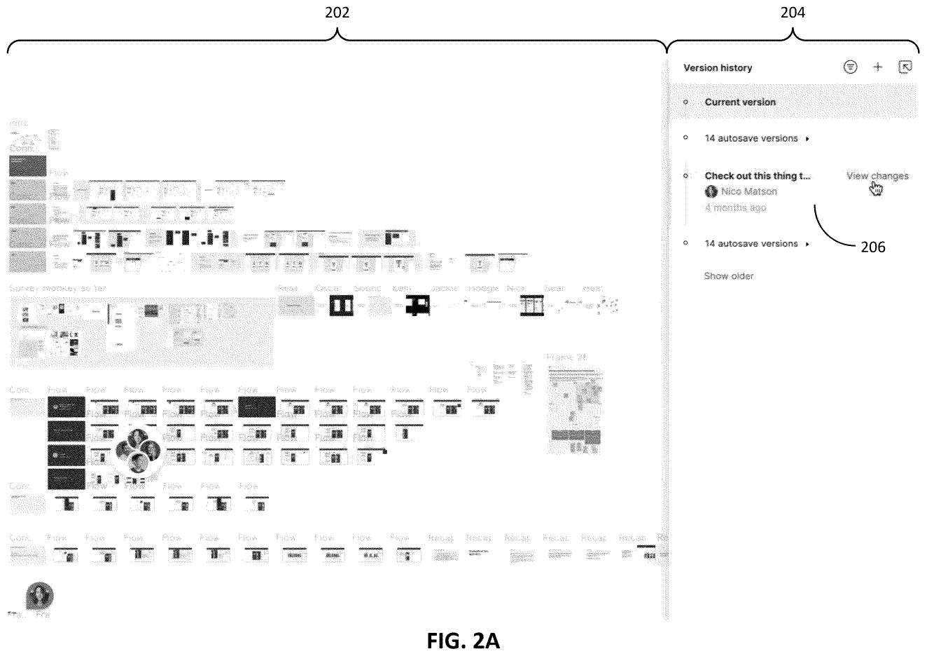

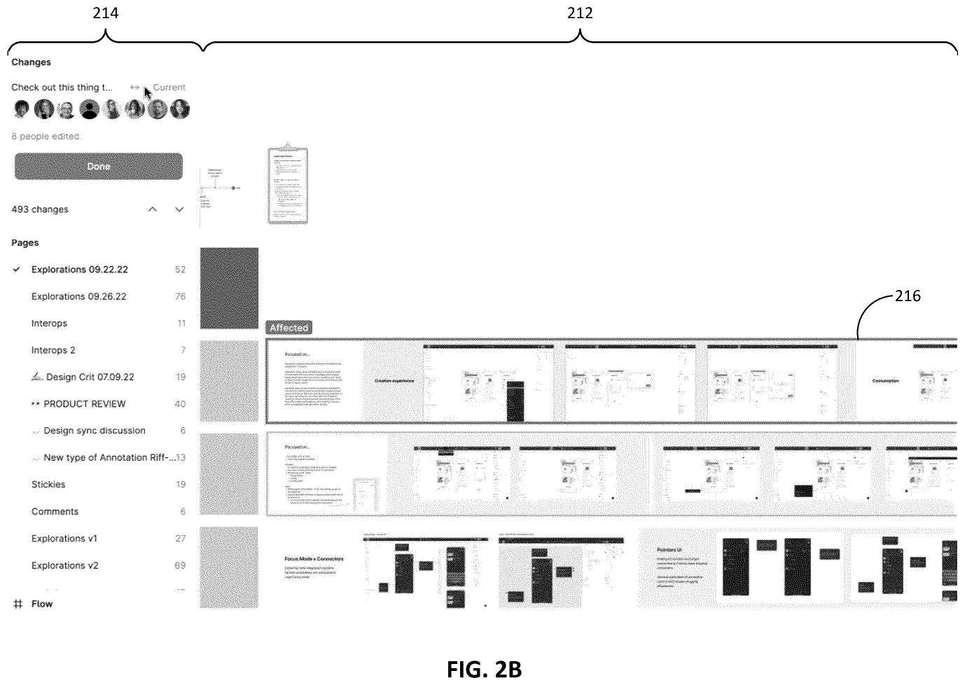

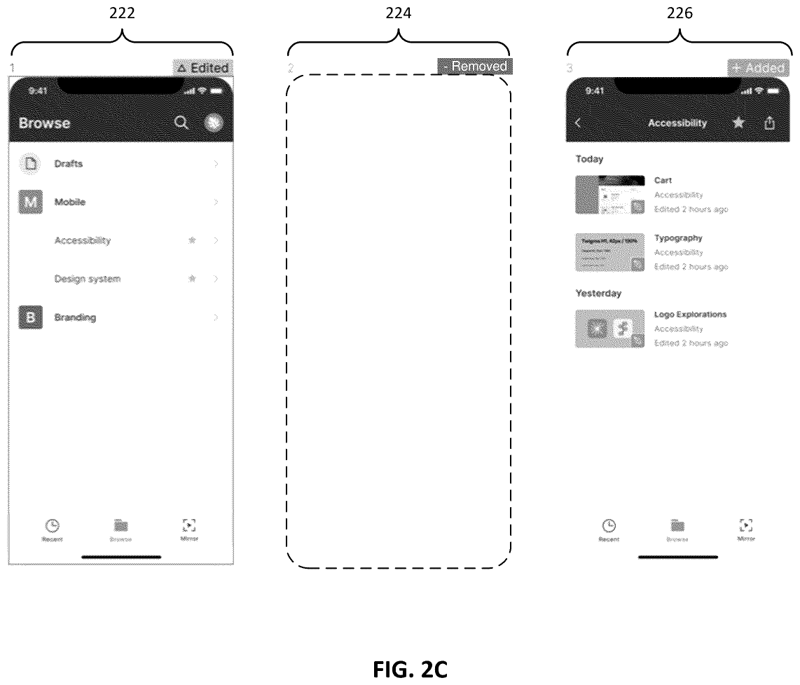

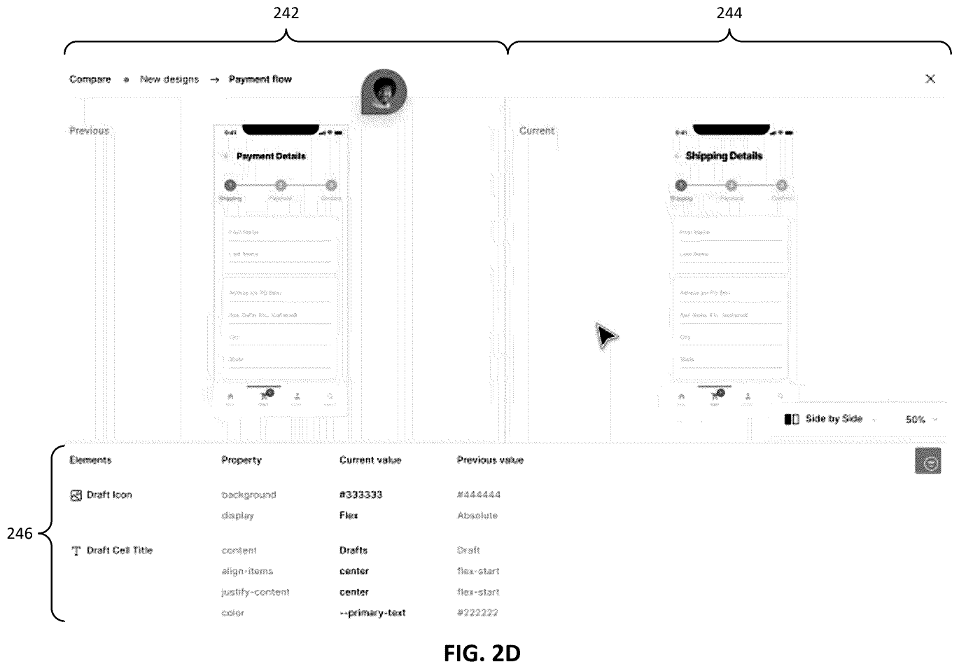

Example user interfaces are presented in FIGS. 2A-2D showing non-limiting examples of visual representations of differences between versions of a design interface. FIG. 2A illustrates an example user interface that includes a visual representation of a set of differences identified between two versions of a design interface, according to one or more examples. The example compare changes interface includes a canvas 202 within which a first version of the design interface is rendered. For example, the canvas 202 may include a rendering of a current version of the design interface and/or a version of the design interface that is newer than the other version of the design interface from which the set of differences is generated.

The example user interface of FIG. 2A also includes a sidebar 204 that displays a version history for the design interface. The version history includes a list of versions of the design interface. These list indicates the design interface includes a current version, 14 autosave versions, and a user-generated version with a name that begins with “Check out this thing.”

The version history additionally includes a user-interface element 206 representing differences between the most recent version of the design interface and an older version of the design interface (e.g., the version with a name that begins with “Check out this thing”). The user-interface element 206 may correspond to a notification that is generated upon determining that the user accessing the version history has not accessed the design interface since the older version. The user-interface element 206 may also, or instead, be generated in response to the user clicking, hovering over, and/or otherwise interacting with the older version of the design interface within the version history. The user-interface element 206 may also, or instead, be generated in response to a request from a different user to have collaborators on the design interface review recent changes made to the design interface since the older version. The user may click on the user-interface element 206 to navigate to a different user interface that includes visual representations of the differences between the two versions of the design interface.

FIG. 2B illustrates an example user interface that includes a visual representation of a set of differences identified between two versions of a design interface, according to one or more examples. A user may access the user interface of FIG. 2B by (for example) clicking on the user-interface element 206 displayed in the sidebar 204 of the user interface of FIG. 2A.

As shown in FIG. 2B, the example user interface includes a canvas 212 and a sidebar 214. The top of the sidebar 214 identifies the two versions of the design interface from which the differences are determined (e.g., the older version with the name that begins with “Check out this thing” and the current version). The top of sidebar 214 also shows avatars of users who have edited the design interface between the older version and the current version, as well as a total number of users (e.g., 8) who have edited the design interface between the older version and the current version.

Next, the sidebar 214 shows the total number of differences (e.g., 493) between the older version and the current version. The sidebar 214 also includes a list of pages affected by the differences (described as changes in the user interface of FIG. 2B). Within the list, the number of changes made to a given page between the older version and the current version is shown to the right of the name of the page. A checkmark is displayed next to the first element in the list (e.g., “Explorations 09.22.22”) to indicate that the corresponding page is currently selected.

The canvas 212 includes a rendering of a version of the design interface, such as the current version of the design interface. Within the canvas 212, a group 216 of design elements is highlighted and labeled as “Affected.” This highlighting and labeling may be generated in response to the selection of the first element in the list of pages within the sidebar 214 (e.g., to allow the user to easily identify the parts of the design interface that correspond to and/or are affected by the changes made to the “Explorations 09.22.22” page between the older version and the newer version).

In some embodiments, the user can navigate between the locations and/or visual representations of the differences within the design interface by interacting with the up and down arrows to the right side of “493 changes” shown in the sidebar 214. More specifically, the set of 493 differences between the older and newer versions of the design interface may be ordered and/or related to one another based on the locations of the corresponding design elements affected by the differences. The user may click on the up and down arrows to the right side of “493 changes” within the sidebar 214 to iterative over the differences based on these annotations. For example, while the user interface of FIG. 2B is displayed to the user, a “most relevant” difference may be selected as the difference that is closest to the center of (or another location in) the viewport associated with the canvas 212 (e.g., the portion of the canvas 212 that is currently viewable within the user interface). Spatial relationships, orderings, and/or other annotations associated with the most relevant difference and other differences may also be used to determine a “previous” difference and/or a “next” difference to which the user can navigate. The user may click on the up arrow to navigate to the previous difference and on the down arrow to navigate to the next difference. In response to the user clicking on a given arrow, the user interface may generate an animation that moves the center (or another location associated with the most relevant difference) of the viewport to the design element affected by the corresponding difference. If the design element is in a different page of the design interface, the user interface may also update sidebar 214 to move the checkmark to be next to the name of the page and generate highlighting and an “Affected” label around a set of design elements within the page.

Further, the ordering and/or spatial relationships associated with the locations of design elements affected by the differences can be used to minimize “jumping” around the canvas 212 as the user navigates across the differences using the up and down arrows. For example, the canvas 212 may be divided into a grid of vertical columns and horizontal rows. An ordering of the 493 changes made between the two versions of the design interface may be generated so that the ordering begins with the leftmost design element in the topmost row and proceeds to design elements that are increasingly farther right in the topmost row until the end of the row is reached. The ordering may then proceed to design elements in a given horizontal direction (e.g., left to right or right to left) in the next highest row until all design elements affected by differences in that row have been added to the ordering. Ordering of the changes in this manner may continue until the leftmost (or rightmost) design element in the lowest row is reached. As the user moves forward or backward within the ordering (e.g., by clicking on the up and/or down arrows), the viewport associated with the canvas 212 may be updated to focus on and/or display the design elements affected by the differences. Because the ordering is generated to reduce and/or minimize distances between consecutive elements, the viewport may make relatively small jumps between design elements as the user navigates to different design elements associated with differences in the ordering.

FIG. 2C illustrates an example user interface that includes a visual representation of a set of differences identified between two versions of a design interface, according to one or more examples. More specifically, FIG. 2C illustrates a set of on-canvas labels 222, 224, and 226 representing differences between an older version of the design interface and a newer version of the design interface.

Each of labels 222, 224, and 226 is associated with a different portion of the design interface, such as different pages and/or frames in the design interface.

Label 222 includes an indicator of “Edited” to specify that the corresponding portion of the design interface has been edited between the older version and the newer version. Label 224 includes an indicator of “Removed” to specify that the corresponding portion of the design interface has been removed between the older version and the newer version. Label 224 is additionally shown with a “ghost frame” to further indicate that the content within the corresponding portion of the design interface has been deleted. Label 226 includes an indicator of “Added” to specify that the corresponding portion of the design interface has been added between the older version and the newer version.

In some embodiments, on-canvas labels can include another indicator (not shown in FIG. 2C) of “Updated” to specify that an external library was changed, and that the change affects the corresponding portion of the design interface. For example, one or more portions of the design interface may be defined in one or more external libraries that are imported for use in the design interface. A given external library may be added, removed, or changed between two versions of the design interface. Thus, the “Updated” indicator communicates to a user that a change to a given portion of the design interface was caused by a change to an external library component used to define or generate the portion of the design interface.

FIG. 2D illustrates an example user interface that includes a visual representation of a set of differences identified between two versions of a design interface, according to one or more examples. As shown in FIG. 2D, the example user interface includes a side-by-side view of the differences between an older (e.g. “Previous”) version of the design interface and a newer (e.g., “Current”) version of the design interface. In some examples, the side-by-side view is presented when a particular difference is selected in another user interface, such as the user interfaces of FIGS. 2A, 2B, and/or 2C.

The side-by-side view includes a first side 242 that shows a portion of the older version of the design interface and a second side 244 that includes the same portion of the newer version of the design interface. For example, each side 242 and 244 may include a rendering of a page represented by a node and/or a chunk in a corresponding version of the design interface.

The example user interface of FIG. 2D also includes a table 246 that provides a summary of the differences between the versions rendered in the first side 242 and second side 244. The first column of the table 246 includes elements affected by the differences. The second column of the table 246 includes properties within the elements that are affected by the differences. The third column of the table 246 includes current values of the properties (e.g., values of the properties in the newer version), and the fourth column of the table 246 includes previous values of the properties (e.g., values of the properties in the older version).

### Examples—Chunk (Related Differences)

A chunk of related differences, or chunk, is a logical grouping of one or more related differences. For example, if the set of differences between two versions of a design interface includes an edited color property and an edited font property for a particular button component, a chunk may include both differences for the particular button component. The IGDS (e.g., IGDS 100) may render a review interface that includes a visual representation of the chunk of related differences.

In some examples, one or more chunks are determined based on a hierarchical structure of the workspace data. For example, each version of a design interface may be represented by a set of workspace data that describes a graph of nodes and edges. To determine differences between two versions of the design interface, the corresponding graphs may be compared on a node-by-node basis. One or more differences that are associated with a particular node in one or both graphs may also be logically grouped into a chunk. The chunk may also be associated with a label indicating whether the differences related to an addition of the node, a removal of the node, editing of the node, and/or updating of an external library associated with the node.

In another example, a chunk may include differences identified in a node and one or more of its child nodes. In this example, the parent node may include a display node, and the changes in the display node and one or more child nodes of the display node may be rendered as a single visual representation of the chunk. Because the visual representation groups related differences identified within a subgraph of the hierarchical structure under a chunk, the visual representation may provide the user adequate context to understand the change(s) made to the corresponding portion(s) of the design interface.

In one or more embodiments, a chunk may be defined to represent different levels of the hierarchical structure and/or different portions of the design interface. For example, a chunk may correspond to a top-level node, a page, a style, and/or a component within the hierarchical structure and/or design interface.

### Methodology

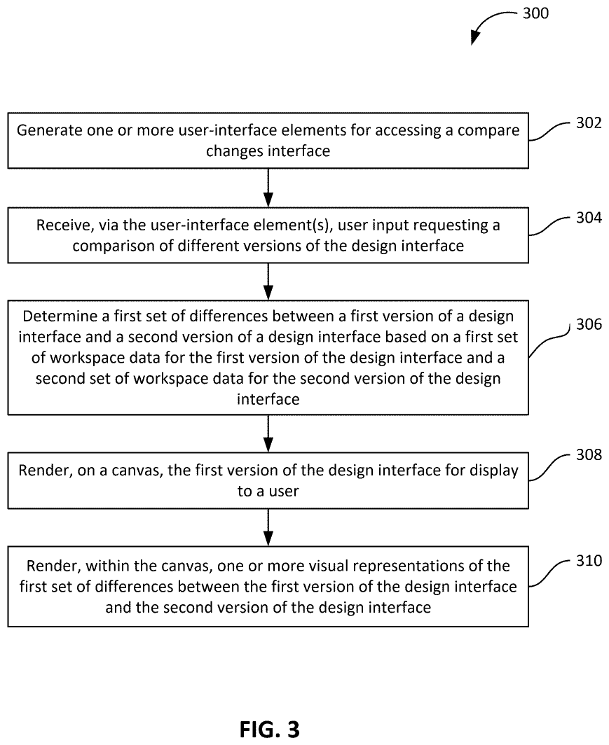

FIG. 3 illustrates a process 300 for tracking and comparing changes in a design interface, according to one or more examples. Process 300 may be performed by one or more computing devices and/or processes thereof. For example, one or more blocks of process 300 may be performed by a user computing device (e.g., user computing devices 10-12, 600). In some examples, one or more blocks of process 300 are performed by a user computing device executing IGDS instructions provided by a network computer system (e.g., network computer system 150, 50) and/or by the network computer system.

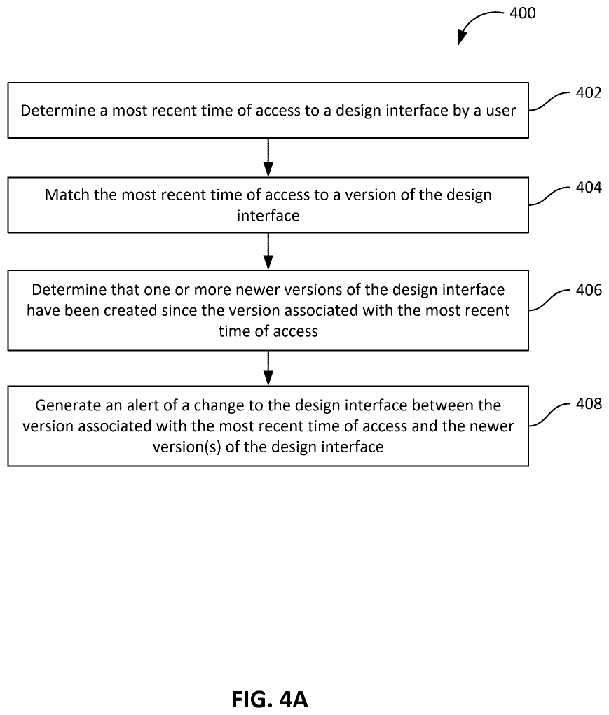

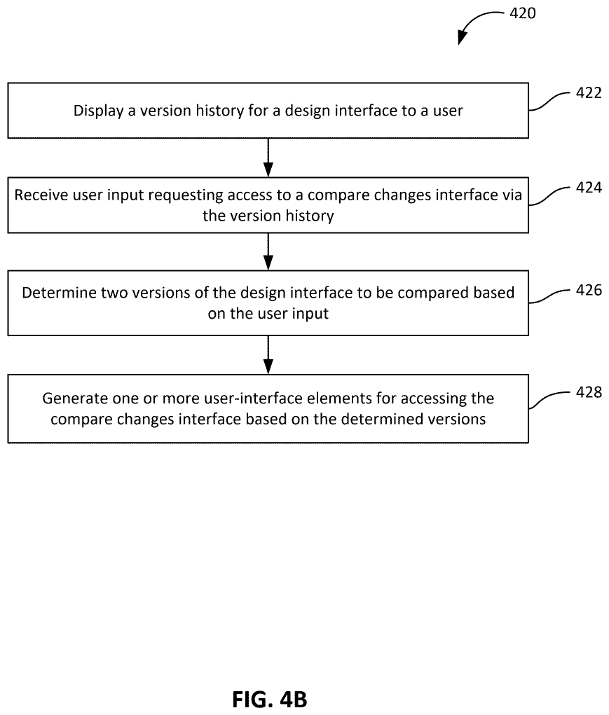

At block 302, a computing device, which may include (but is not limited to) the user computing device and/or network computer system, generates one or more user-interface elements for accessing a compare changes interface, as described in further detail below with respect to FIGS. 4A-4B. At block 304, the user computing device receives, via the user-interface element(s), user input requesting a comparison of different versions of the design interface. For example, the user input may include clicking, hovering over, and/or otherwise interacting with the user-interface element(s) generated in block 302.

At block 306, the computing device determines a first set of differences between a first version of a design interface and a second version of a design interface based on a first set of workspace data for the first version of the design interface and a second set of workspace data for the second version of the design interface. For example, the user computing device may compare nodes and/or other elements of hierarchical structures represented by the first and second sets of workplace data to determine the differences between the corresponding versions of the design interface. The user computing device may also generate logical groupings of the differences under “chunks” representing components, styles, top-level nodes, pages, and/or other entities associated with nodes and/or other elements of the hierarchical structures.

At block 308, the computing device renders, on a canvas, the first version of the design interface for display to a user. For example, the user computing device may render the older version or the newer version of the design interface associated with the differences.

At block 310, the computing device renders, within the canvas, one or more visual representations of the first set of differences between the first version of the design interface and the second version of the design interface. For example, the user computing device may display highlighted portions of the design interface; a list of design elements affected by the differences; on-canvas labels indicating added design elements, removed design elements, edits to design elements, updates to external libraries associated with design elements, and/or other types of changes made to specific design elements; side-by-side comparisons of different versions of design elements; and/or other visual representations of the differences. The user computing device may also provide user-interface elements that allow the user to navigate between design elements affected by the differences and/or logical groupings of the differences. During this navigation, the user computing device may “jump” from a design element that is currently displayed within a viewport for the canvas to another user-interface element that is spatially proximate to the design element to minimize the appearance of bouncing around the canvas as the user steps through the differences and/or logical groupings.

FIG. 4A illustrates a process 400 for generating an entry point to a compare changes interface, according to one or more examples. Process 400 may be performed by one or more computing devices and/or processes thereof. For example, one or more blocks of process 300 may be performed by a user computing device (e.g., user computing devices 10-12, 600). In some examples, one or more blocks of process 300 are performed by a user computing device executing IGDS instructions provided by a network computer system (e.g., network computer system 150, 50) and/or by the network computer system.

In block 402, a computing device, which may include (but is not limited to) the user computing device and/or network computer system, determines a most recent time of access to a design interface by a user. For example, the computing device may retrieve the most recent time of access as a timestamp from a database that logs visits to the IGDS by users.

In block 404, the computing device matches the most recent time of access to a version of the design interface. For example, the computing device may use a version history for the design interface to determine the current version of the design interface that was available at the most recent time of access.

In block 406, the computing device determines that one or more newer versions of the design interface have been created since the version associated with the most recent time of access. For example, the computing device may use the version history to identify the newer version(s) as one or more versions of the design interface that were created after the version associated with the most recent time of access.

In block 408, the computing device generates an alert of a change to the design interface between the version associated with the most recent time of access and the newer version(s) of the design interface. For example, the computing device may transmit the alert to the user and/or other users (e.g., collaborators on the same design interface) as a notification within the computing device, in an email, and/or via another communication channel.

FIG. 4B illustrates a process 420 for generating an entry point to a compare changes interface, according to one or more examples. Process 420 may be performed by one or more computing devices and/or processes thereof. For example, one or more blocks of process 300 may be performed by a user computing device (e.g., user computing devices 10-12, 600). In some examples, one or more blocks of process 300 are performed by a user computing device executing IGDS instructions provided by a network computer system (e.g., network computer system 150, 50) and/or by the network computer system.

In block 422, a computing device, which may include (but is not limited to) the user computing device and/or network computer system, displays a version history for a design interface to a user. For example, the computing device may display the version history in a sidebar and/or another portion of a user interface. The version history may include a list of versions of the design interface, names and/or descriptions associated with the versions, times at which the versions were created, and/or other metadata related to the versions. The versions in the list may be ordered and/or grouped by ascending or descending creation time, name, creator, and/or other attributes in the metadata.

In block 424, the computing device receives user input requesting access to a compare changes interface via the version history. For example, the computing device may detect the user input as the user hovering a cursor over a given version of the design interface within the version history, followed by the user selecting a user-interface element indicating that the user would like to compare the version with another version of the design interface (e.g., the current version of the design interface, another version selected by the user, etc.).

In block 426, the computing device determines two versions of the design interface to be compared based on the user input. Continuing with the above example, the computing device may obtain one or both versions from the user input. The computing device may also, or instead, determine that the versions should include the current version of the design interface, a version that was last accessed by the user, a version that was flagged by a different user as a point of comparison, and/or a version that is otherwise not specified in the user input.

In block 428, the computing device generates one or more user-interface elements for accessing the compare changes interface based on the determined versions. For example, the computing device may add the user-interface element(s) to the portion of the user interface within which the version history is shown. The user-interface element(s) may indicate the versions of the design interface being compared and/or other metadata associated with one or both versions. The user may click on and/or otherwise interact with the user-interface element(s) to navigate to the compare changes interface. The user may then use the compare changes interfaces to review, comment on, and/or perform other actions related to the differences between the two versions, as discussed above.

### Network Computer System

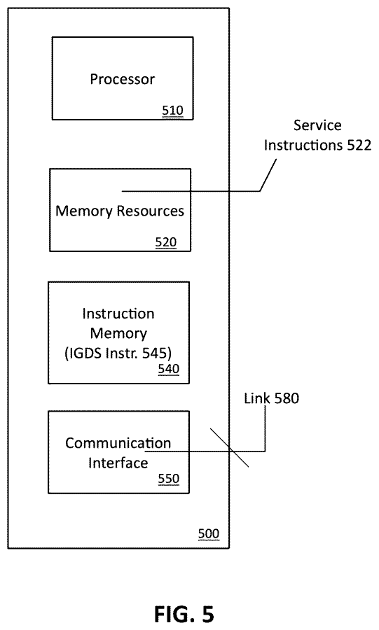

FIG. 5 illustrates a computer system on which one or more embodiments can be implemented. A computer system 500 can be implemented on, for example, a server or combination of servers. For example, the computer system 500 may be implemented as the network computer system 150 of FIG. 1A through FIG. 1C.

In one implementation, the computer system 500 includes processing resources 510, memory resources 520 (e.g., read-only memory (ROM) or random-access memory (RAM)), one or more instruction memory resources 540, and a communication interface 550. The computer system 500 includes at least one processor 510 for processing information stored with the memory resources 520, such as provided by a random-access memory (RAM) or other dynamic storage device, for storing information and instructions which are executable by the processor 510. The memory resources 520 may also be used to store temporary variables or other intermediate information during execution of instructions to be executed by the processor 510.

The communication interface 550 enables the computer system 500 to communicate with one or more user computing devices, over one or more networks (e.g., cellular network) through use of the network link 580 (wireless or a wire). Using the network link 580, the computer system 500 can communicate with one or more computing devices, specialized devices and modules, and/or one or more servers.

In examples, the processor 510 may execute service instructions 522, stored with the memory resources 520, in order to enable the network computing system to implement the network service 152 and operate as the network computer system 150 in examples such as described with FIG. 1A through FIG. 1C.

The computer system 500 may also include additional memory resources (“instruction memory 540”) for storing executable instruction sets (“IGDS instructions 545”) which are embedded with web pages and other web resources, to enable user computing devices to implement functionality such as described with the IGDS 100.

As such, examples described herein are related to the use of the computer system 500 for implementing the techniques described herein. According to an aspect, techniques are performed by the computer system 500 in response to the processor 510 executing one or more sequences of one or more instructions contained in the memory 520. Such instructions may be read into the memory 520 from another machine-readable medium. Execution of the sequences of instructions contained in the memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

### User Computing Device

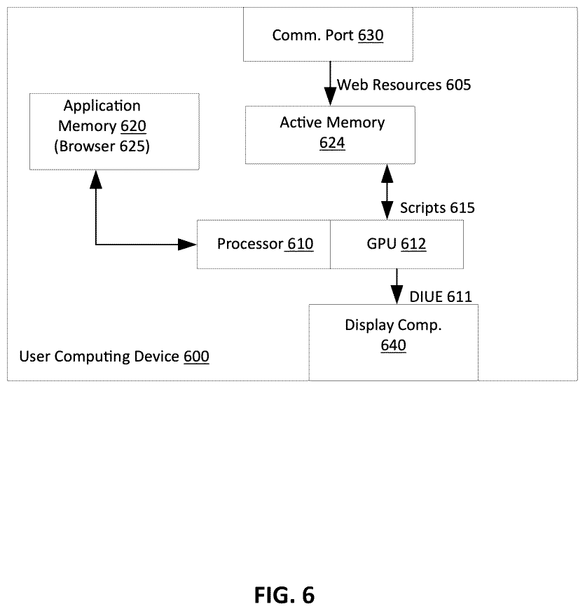

FIG. 6 illustrates a user computing device for use with one or more examples, as described. In examples, a user computing device 600 can correspond to, for example, a work station, a desktop computer, a laptop or other computer system having graphics processing capabilities that are suitable for enabling renderings of design interfaces and graphic design work. In variations, the user computing device 600 can correspond to a mobile computing device, such as a smartphone, tablet computer, laptop computer, VR or AR headset device, and the like.

In examples, the computing device 600 includes a central or main processor 610, a graphics processing unit (GPU) 612, memory resources 620, and one or more communication ports 630. The computing device 600 can use the main processor 610 and the memory resources 620 to store and launch a browser 625 or other web-based application. A user can operate the browser 625 to access a network site of the network service 152, using the communication port 630, where one or more web pages or other resources 605 for the network service 152 (see FIG. 1A through FIG. 1C) can be downloaded. The web resources 605 can be stored in the active memory 624 (cache).

As described by various examples, the processor 610 can detect and execute scripts and other logic which are embedded in the web resources 605 in order to implement the IGDS 100 (see FIG. 1A through FIG. 1C). In some of the examples, some of the scripts 615 which are embedded with the web resources 605 can include GPU accelerated logic that is executed directly by the GPU 612. The main processor 610 and the GPU can combine to render a design interface under edit (“DIUE 611”) on a display component 640. The rendered design interface can include web content from the browser 625, as well as design interface content and functional elements generated by scripts and other logic embedded with the web resources 605. By including scripts 615 that are directly executable on the GPU 612, the logic embedded with the web resources 605 can better execute the IGDS 100, as described with various examples.

### CONCLUSION

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A network computer system comprising:
a memory sub-system to store a set of instructions; and
one or more memory resources storing interactive graphic design system instructions that, when executed by one or more processors, cause the one or more processors to perform operations that comprise providing workspace data describing one or more design interfaces and the interactive graphic design system instructions to a user computing device, wherein the interactive graphic design system instructions, when executed at the user computing device, causes the user computing device to perform operations comprising:
determining a first set of differences between a first version of a design interface and a second version of the design interface based on a comparison of a first set of workspace data for the first version of the design interface with a second set of workspace data for the second version of the design interface;
rendering, on a canvas, the first version of the design interface for display to a user at the user computing device; and
rendering, within the canvas, one or more visual representations of the first set of differences between the first version of the design interface and the second version of the design interface.

2. The network computer system of claim 1, wherein determining the first set of differences comprises:
matching one or portions of a hierarchical structure associated with at least one of the first set of workspace data or the second set of workspace data to a second set of differences that is a subset of the first set of differences; and
generating a logical grouping of the second set of differences within the first set of differences.

3. The network computer system of claim 2, wherein matching the one or more portions of the hierarchical structure to the second set of differences comprises determining that the second set of differences is associated with a node in the hierarchical structure.

4. The network computer system of claim 2, wherein the one or more visual representations include a summary of the second set of differences within a portion of the design interface.

5. The network computer system of claim 2, wherein the logical grouping corresponds to at least one of a component, a style, a top-level node, or a page.

6. The network computer system of claim 1, wherein the one or more visual representations include an on-canvas label indicating a portion of the design interface that is affected by one or more differences in the first set of differences.

7. The network computer system of claim 6, wherein the on-canvas label further indicates at least one of an added design element, an edited design element, a removed design element, or a change to an external library used to define a design element.

8. The network computer system of claim 1, wherein the one or more visual representations include at least one of a ghost frame representing a deletion of a deleted design element or a highlighting of a design element that is affected by one or more differences in the first set of differences.

9. The network computer system of claim 1, wherein the operations further comprise:
determining the second version of the design interface based on a time at which the design interface was accessed by the user; and
generating an alert of a change to the design interface between the second version and the first version.

10. The network computer system of claim 1, wherein the operations further comprise:
displaying a list of versions of the design interface; and
receiving, via the displayed list of versions of the design interface, a selection of the second version of the design interface prior to rendering the one or more visual representations of the first set of differences within the canvas.

11. The network computer system of claim 1, wherein the first version of the design interface comprises a most recent version of the design interface and the second version of the design interface comprises an older version of the design interface.

12. The network computer system of claim 1, wherein rendering the one or more visual representations comprises:
rendering, within a viewport associated with the canvas, a first visual representation of a first difference in the first set of differences;
receiving user input to navigate to a second difference in the first set of differences;
determining the second difference based on a proximity to the viewport; and
rendering, within the viewport, a second visual representation of the second difference.

13. A non-transitory computer-readable medium that stores instructions, executable by one or more processors, to cause the one or more processors to perform operations comprising:
determining a first set of differences between a first version of a design interface and a second version of the design interface based on a comparison of a first set of workspace data for the first version of the design interface with a second set of workspace data for the second version of the design interface;
rendering, on a canvas, the first version of the design interface for display to a user; and
rendering, within the canvas, one or more visual representations of the first set of differences between the first version of the design interface and the second version of the design interface.

14. The non-transitory computer-readable medium of claim 13, wherein determining the first set of differences comprises:
determining the first set of differences based on a comparison of a first hierarchical structure represented by the first set of workspace data and a second hierarchical structure represented by the second set of workspace data; and
generating one or more logical groupings of the first set of differences under one or more nodes of the first hierarchical structure.

15. The non-transitory computer-readable medium of claim 14, wherein the one or more visual representations include a summary of one or more differences within a logical grouping in the one or more logical groupings.

16. The non-transitory computer-readable medium of claim 14, wherein the one or more nodes represent at least one of a component, a style, a top-level node, or a page.

17. The non-transitory computer-readable medium of claim 13, wherein the one or more visual representations include an on-canvas label indicating (i) a portion of the design interface that is affected by one or more differences in the first set of differences and (ii) a type of change associated with the one or more differences, wherein the type of change comprises at least one of an added design element, an edited design element, a removed design element, or a change to an external library associated with a design element.

18. The non-transitory computer-readable medium of claim 13, wherein the one or more visual representations include at least one of a ghost frame representing a deletion of a deleted design element or a highlighting of a design element that is affected by one or more differences in the first set of differences.

19. A method for operating a computing device comprising one or more processors, the method comprising:
determining a first set of differences between a first version of a design interface and a second version of the design interface based on a comparison of a first set of workspace data for the first version of the design interface with a second set of workspace data for the second version of the design interface;
rendering, on a canvas, the first version of the design interface for display to a user; and
rendering, within the canvas, one or more visual representations of the first set of differences between the first version of the design interface and the second version of the design interface.

20. The method of claim 19, wherein rendering the one or more visual representations comprises:
rendering, within a viewport associated with the canvas, a first visual representation of a first difference in the first set of differences;
receiving user input to navigate to a second difference in the first set of differences;
determining the second difference based on a proximity to the viewport; and
rendering, within the viewport, a second visual representation of the second difference.
